(19) United States
(12) Patent Application Publication
(10) Pub. No.: US 2026/0072459 A1
(43) Pub. Date: Mar. 12, 2026

(54) DISPLACEMENT INTENSIFIER, SYSTEM, AND METHOD

(71) Applicant: Kraft Werks Group, LLC, Medina, OH (US)

(72) Inventor: Edward A. Dray, Uniontown, OH (US)

(21) Appl. No.: 19/392,680

(22) Filed: Nov. 18, 2025

Related U.S. Application Data
(63) Continuation-in-part of application No. 18/237,335, filed on Aug. 23, 2023, now Pat. No. 12,540,631.

(51) Int. Cl. G05D 16/20

(52) U.S. Cl. CPC G05D 16/2066

(57) ABSTRACT

An intensifier system, and method may increase a pressure of a fluid within a volume by displacing a portion of the fluid within the volume rather than by adding additional pressurized fluid to the volume. Therefore, a displacement intensifier may comprise a rod that is inserted into the volume to partially displace the fluid within the volume and thereby cause a proportional increase in the pressure of the fluid within the volume. The intensifier system may also introduce a pressurized fluid into the volume to supplement the increase in pressure of the fluid caused by the displacement of the rod within the volume.

### BACKGROUND

The primary function of an intensifier may be to increase the pressure of a medium, such as a fluid, within a system. Intensifiers may convert a relatively low input fluid pressure to a relatively high output fluid pressure. The input fluid and the output fluid may be the same fluid medium, or they may be different fluid mediums. Common fluid mediums include, water, hydraulic fluid, and sometimes air. Intensifiers may contain pistons, plungers, and the like of various ratios to increase the pressure of the fluid medium. Because pressure varies inversely with surface area, an intensifier may have, for example, two plungers, each having a different surface area. As such, an intensifier may leverage a relatively low-pressure volume of hydraulic fluid acting on a plunger having a relatively large surface area, against a plunger having a relatively small surface area acting on a relatively high-pressure volume of water. As a result, increasing the pressure of the hydraulic fluid creates a proportionately higher pressure increase of the water, where the proportion of this increase is based on the ratio of the input and output plunger surface areas.

Conventional intensifiers may increase the pressure of a medium within a volume by introducing an additional amount of pressurized medium into the volume. For example, an intensifier may increase the pressure of water in a tank by introducing additional water into the tank. The additional water may be increasingly pressurized by the intensifier to further increase the pressure of the water in the tank.

However, physical limitations may exist that make it difficult to attain a desired pressure rise with a conventional intensifier. These limitations may include cost, size, controllability, reliability, speed, accuracy, and energy requirements. Accordingly, what is needed is an intensifier, system, and method that overcomes at least some of the limitations noted above.

### SUMMARY

An intensifier system may comprise an intensifier and a system manifold. The intensifier may comprise an intensifier cylinder, which may comprise a control medium chamber that may be configured to contain a pressurized control medium and to fluidly couple to at least one control medium inlet. The intensifier may comprise an intensifier piston that may be configured to mechanically couple to an intensifier rod, which may extend from a first face of the intensifier piston. The system manifold may comprise a process medium chamber that may be configured to contain a pressurized process medium and to fluidly couple to at least one process medium intensifier inlet. The system manifold may comprise at least one process medium inlet check valve that may be configured to fluidly couple to the respective process medium intensifier inlet. The intensifier rod may be configured to extend axially from the intensifier cylinder, through the system manifold, and into the process medium chamber. The pressure of the process medium within the process medium chamber may change in proportion to the length of the intensifier rod extending into the process medium chamber. The intensifier may be configured to change the process medium pressure upon receiving commands from an intensifier control system.

The intensifier system may comprise at least one of: an intensifier, a system manifold, a coupler, a control system. The intensifier may comprise an intensifier cylinder, which may comprise a control medium chamber that may be configured to contain a pressurized control medium and to fluidly couple to at least one control medium inlet. The intensifier may comprise an intensifier piston that may be configured to mechanically couple to an intensifier rod, which may extend from a first face of the intensifier piston. The system manifold may comprise a process medium chamber that may be configured to contain a pressurized process medium and to fluidly couple to at least one process medium intensifier inlet. The system manifold may comprise at least one process medium inlet check valve that may be configured to fluidly couple to the respective process medium intensifier inlet. The coupler may be configured to mechanically couple the system manifold to a pressure vessel and fluidly couple the process medium chamber to the pressure vessel. The intensifier rod may be configured to extend axially from the intensifier cylinder, through the system manifold, and into the process medium chamber. The pressure of the process medium within the process medium chamber may change in proportion to the length of the intensifier rod extending into the process medium chamber. The control system may be configured to operate the intensifier and may comprise at least one of: at least one control medium power unit; at least one control medium proportional control valve that may be configured to fluidly couple between the respective control medium power unit and the respective control medium inlet; at least one proportional integration regulator that may be configured to electronically couple to the respective control medium proportional control valve; at least one process medium pressure sensor that may be configured to measure the process medium pressure; at least one control medium drain valve that may be configured to fluidly couple to the respective control medium inlet; and at least one programmable logic controller that may be configured to execute a control system logic comprising a sequence of commands. The at least one programmable logic controller may be configured to electrically couple to at least one of: the at least one control medium power unit; the at least one control medium proportional control valve; the at least one proportional integration regulator; the at least one process medium pressure sensor; and the at least one control medium drain valve.

A method for operating an intensifier system for a process medium may comprise controlling a control medium of the intensifier system with a programmable logic controller. The intensifier system may comprise a primary intensifier that may be configured to fluidly couple in series to a secondary intensifier. The primary intensifier may be configured to increase a pressure of the process medium within a pressure vessel by partially displacing the process medium contained within the pressure vessel. The programmable logic controller may be configured to control a pressurization phase and a depressurization phase. The pressurization phase may comprise pressurizing the primary intensifier until the process medium pressure nears a process medium transition pressure, wherein the process medium transition pressure may be the maximum process medium pressure able to be generated by the primary intensifier. The pressurization phase may comprise pressurizing the secondary intensifier until the process medium pressure reaches a process medium test pressure. A process medium pilot-operated check valve may be configured to fluidly couple between the primary intensifier and the secondary intensifier and may be operated by the programmable logic controller in a closed position during the depressurization phase. The method may comprise opening the process medium pilot-operated check valve with the programmable logic controller and depressurizing the primary intensifier and the secondary intensifier until the process medium pressure nears or reaches zero. The method may comprise at least one pressure sensor that may be configured to measure the process medium pressure within the primary intensifier. At least one control medium proportional control valve may be configured to pressurize the respective intensifier, and at least one proportional integration regulator may be configured to control the respective control medium proportional control valve. The programmable logic controller may be configured to control each proportional integration regulator.

### BRIEF DESCRIPTION OF THE DRAWINGS

The accompanying figures, which are incorporated in and constitute a part of the specification, illustrate various example aspects, and are used merely to illustrate various example aspects. In the figures, like elements bear like reference numerals.

FIG. 1A illustrates a sectional view of a displacement intensifier 120 in a first position.

FIG. 1B illustrates a sectional view of the displacement intensifier 120 in a second position.

FIG. 2 illustrates a sectional view of a coupler 266 for an intensifier system 200.

FIG. 3 illustrates a schematic of an intensifier system 300, a sectional view of a displacement intensifier 320, and a schematic for a control system 370.

FIG. 4A illustrates a schematic of an intensifier system 400, a sectional view of a primary intensifier 420p and a secondary intensifier 420s, and a schematic for a control system 470.

FIG. 4B illustrates a diagram of an intensification method 405 having a pressurization phase 410, a depressurization phase 450, and a maintenance phase 480.

### DETAILED DESCRIPTION

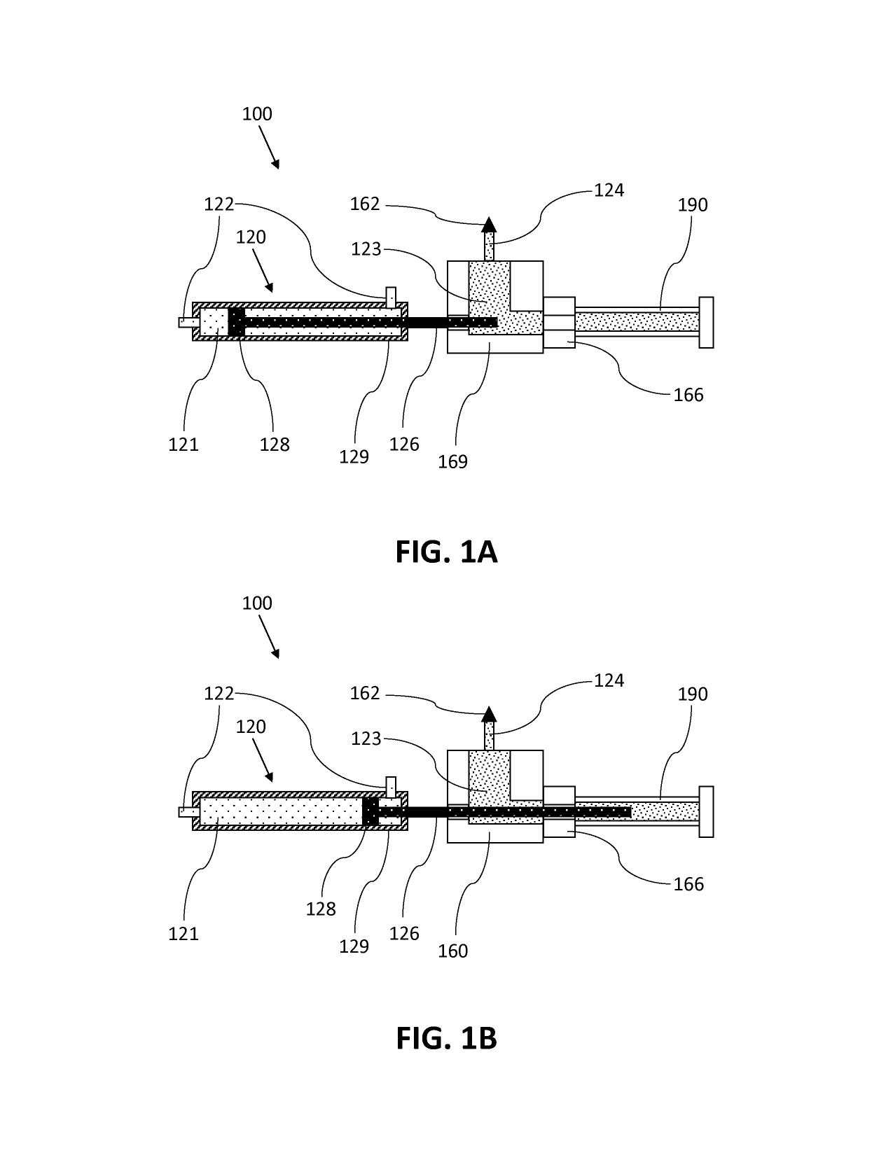

FIGS. 1A and 1B illustrate a first sectional view and a second sectional view of an intensifier system 100, which may comprise a displacement intensifier 120 that may be configured to accommodate both a control medium and a process medium. FIG. 1A illustrates the displacement intensifier 120 in a first position representing a lower-pressure position. FIG. 1B illustrates the displacement intensifier 120 in a second position representing a higher-pressure position. The control medium may comprise a medium that substantially resists compression, such as water, a hydraulic fluid, a non-compressible liquid, and the like. The process medium may comprise a medium that substantially resists compression, such as water, a hydraulic fluid, a non-compressible liquid, and the like. The control medium and the process medium may comprise the same medium, or they may comprise different mediums. As a non-limiting example, the control medium may be a hydraulic fluid and the process medium may be water.

The displacement intensifier 120 may comprise an intensifier cylinder 129. The intensifier cylinder 129 may comprise a control medium chamber 121 configured to contain the control medium under pressure. The control medium chamber 121 may have a cross-sectional area Ac upon which the control medium transfers a control medium pressure Pcm. The intensifier cylinder 129 may be configured to fluidly couple to at least one control medium inlet 122 and thus allow the control medium to enter and exit the control medium chamber 121.

The intensifier cylinder 129 may comprise an intensifier piston 128. The intensifier piston 128 may be configured to mechanically couple to an intensifier rod 126, which may extend from a first face of the intensifier piston 128. The intensifier piston 128 may have a second face opposing the first face. The control medium may enter the control medium chamber 121 from one of the control medium inlets 122 and may force the intensifier piston 128 to move away from the respective control medium inlet 122 when the control medium is pressurized. At least one control medium inlet 122 may be positioned to apply a force on the first face of the intensifier piston 128. At least one control medium inlet 122 may be positioned to apply a force on the second face of the intensifier piston 128. In this manner, the position of the intensifier piston 128, and therefore the position of the intensifier rod 126, may be controlled in two opposing directions by introducing the pressurized control medium into the respective control medium inlets 122.

The intensifier system 100 may comprise a system manifold 169. The system manifold 169 may comprise a process medium chamber 123 configured to contain the process medium under pressure. The process medium chamber 123 may have a cross-sectional area Ap. The cross-sectional area Ap may be consistent throughout the process medium chamber 123. The cross-sectional area Ap may be variable throughout the process medium chamber 123.

The system manifold 169 may be configured to fluidly couple to at least one process medium intensifier inlet 124 and thus allow the process medium to enter and exit the process medium chamber 123, such as to and from a process medium supply. The at least one process medium intensifier inlet 124 may be two process medium intensifier inlets 124, wherein a first process medium intensifier inlet 124 may be configured to fluidly couple to the process medium supply, and wherein a second process medium intensifier inlet 124 may be configured to fluidly couple to a second intensifier (not shown). The system manifold 169 may comprise at least one process medium inlet check valve 162. The process medium inlet check valve 162 may be configured to fluidly couple to the respective process medium intensifier inlet 124. The process medium inlet check valve 162 may prevent the process medium from flowing back out of the process medium chamber 123 through the process medium intensifier inlet 124.

The intensifier rod 126 may be configured to extend axially from the intensifier cylinder 129 of the displacement intensifier 120, through the system manifold 169, and into the process medium chamber 123. The pressure of the process medium Ppm within the process medium chamber 123 may change in proportion to the length of the intensifier rod 126 extending into the process medium chamber 123. Thus, through the displacement of the intensifier rod 126 into the process medium chamber 123, the process medium pressure Ppm may increase without the need to introduce an additional volume of process medium into the process medium chamber 123. The displacement intensifier 120 may be configured to change the process medium pressure Ppm by extending and retracting the intensifier rod 126 upon receiving commands from an intensifier control system (not shown).

The intensifier system 100 may comprise a coupler 166. The coupler 166 may be configured to mechanically couple the system manifold 169 to a pressure vessel 190 and to fluidly couple the process medium chamber 123 to the pressure vessel 190. The pressure vessel 190 may be a pipe, a tube, a tank, or any other device or structure configured to contain the pressurized process medium.

The displacement intensifier 120 may be configured to move fore and aft relative to the system manifold 169 along the axis of the intensifier rod 126. The intensifier rod 126 may be configured to extend into the pressure vessel 190. By extending into the pressure vessel 190, the intensifier rod 126 may increase the process medium pressure Ppm in the pressure vessel 190 by displacing the process medium rather than by introducing an additional volume of process medium into the pressure vessel 190.

When setting up the displacement intensifier 120 for an operation, such as to hydrostatically test the pressure vessel 190, the intensifier rod 126 may need to be partially or fully retracted from the process medium chamber 123. To facilitate this retraction, the displacement intensifier 120 may be moved away from the system manifold 169. As the intensifier rod 126 may be captured in the intensifier cylinder 129, moving the displacement intensifier 120 away from the system manifold 169 also retracts the intensifier rod 126 from the process medium chamber 123.

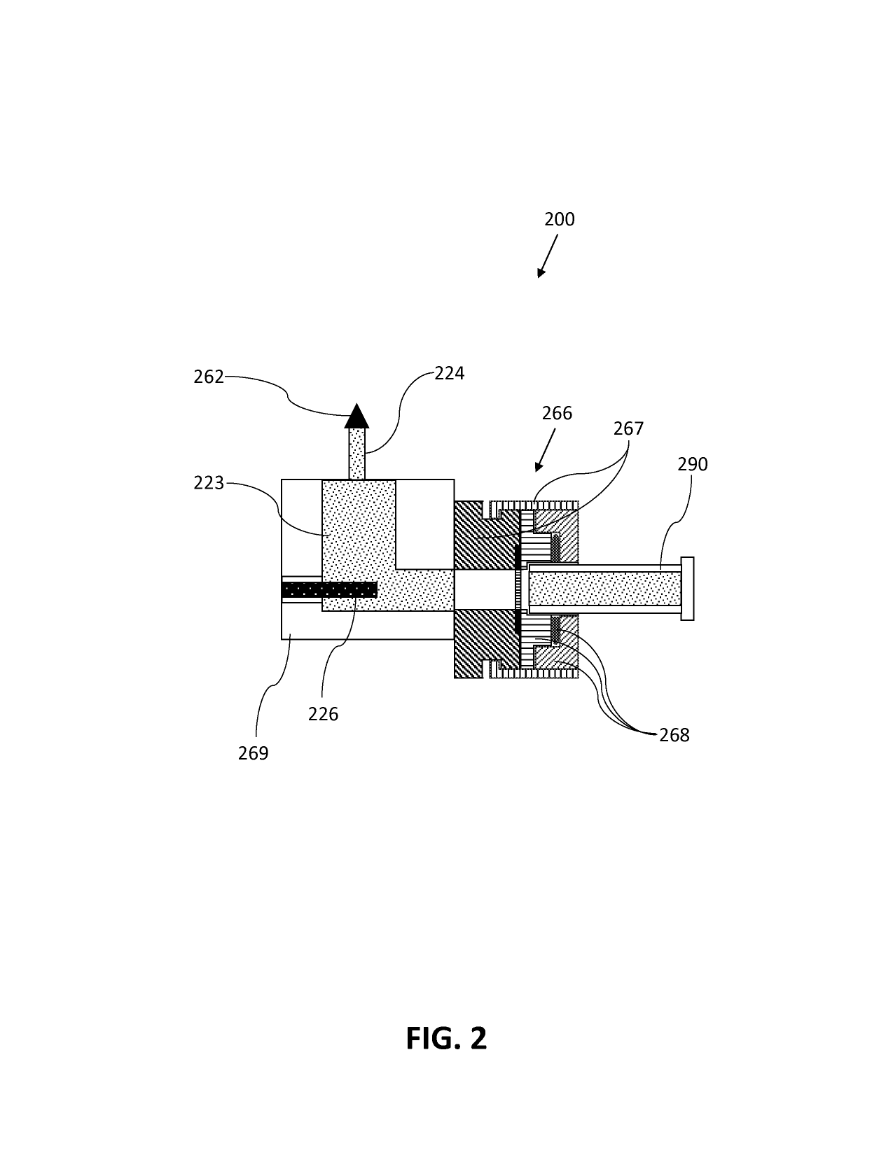

FIG. 2 illustrates a sectional view of a coupler 266 for an intensifier system 200, which may comprise a displacement intensifier (not shown) and a system manifold 269. The intensifier may comprise an intensifier rod 226. The system manifold 269 may comprise a process medium chamber 223, at least one process medium intensifier inlet 224, and at least one process medium inlet check valve 262.

The coupler 266 may comprise a clamp assembly 267. The clamp assembly 267 may may be configured to mechanically align and secure a tooling assembly 268 within the clamp assembly 267. The clamp assembly 267 may comprise a plurality of components configured to mechanically and fluidly couple at least one of the system manifold 269, the tooling assembly 268, and the pressure vessel 290. The tooling assembly 268 may be configured to mechanically align and secure the pressure vessel 290 to the clamp assembly 267. The tooling assembly 268 may comprise a plurality of components configured to mechanically and fluidly couple at least one of the system manifold 269, the clamp assembly 267, and the pressure vessel 290. The tooling assembly 268 may be configured to be at least one of adjustable and interchangeable to be adaptable to mechanically couple the clamp assembly 267 to pressure vessels 290 having various configurations, shapes, sizes, and weights. One skilled in the art would understand that the specific clamping and tooling assemblies may not be particularly limited and may be selected from any combination of clamping and tooling assemblies that would align and secure the pressure vessel 290 to the system manifold 269 both mechanically and fluidly.

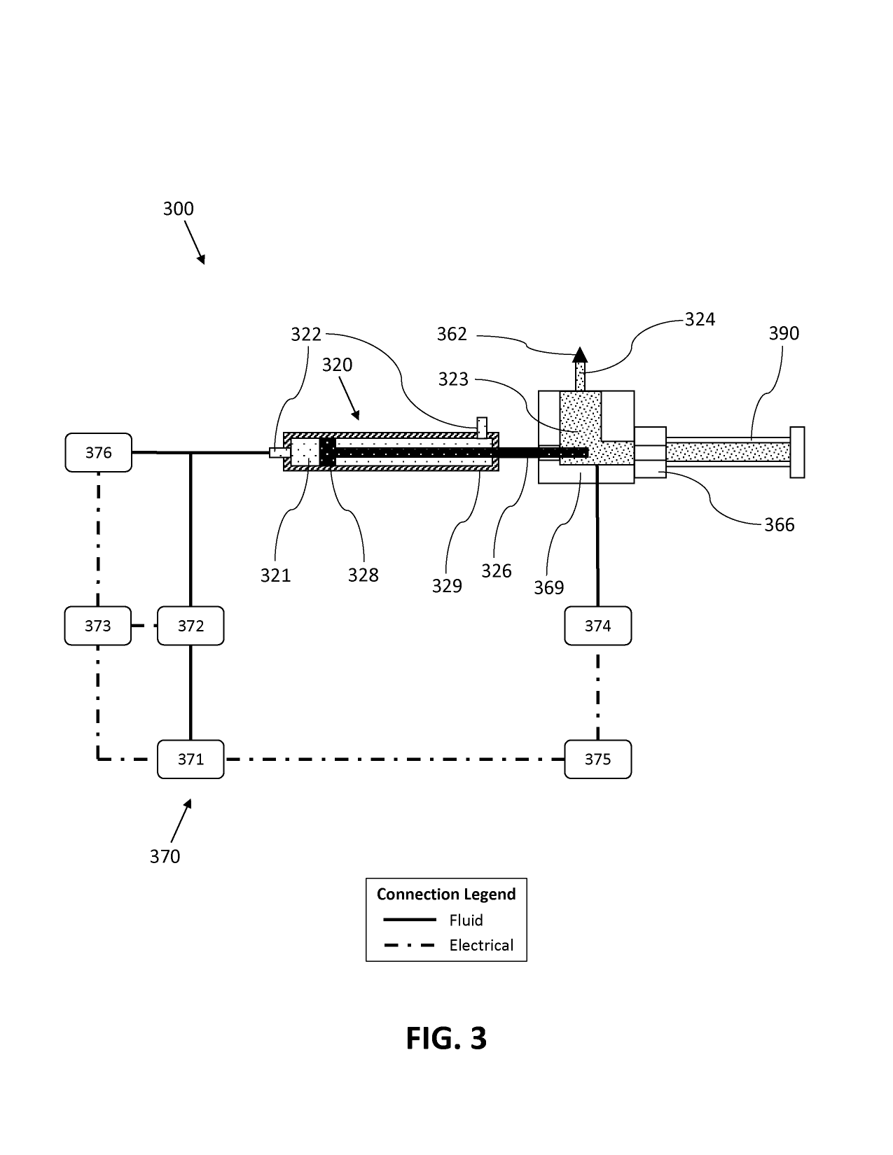

An intensifier system 300 may comprise at least one of a displacement intensifier 320 and a control system 370. FIG. 3 illustrates a schematic of the intensifier system 300, a sectional view of the displacement intensifier 320, and a schematic for the control system 370. The displacement intensifier 320, as illustrated in FIG. 3, may be substantially the same, in both structure and function, as the displacement intensifier 120, as illustrated in FIGS. 1A and 1B. As such, like numerals represent like elements (e.g., 120 = 320 and 169 = 369, etc.).

The control system 370 may be configured to operate the displacement intensifier 320 and may comprise at least one control medium power unit 371. The control system 370 may comprise at least one control medium proportional control valve (PCV) 372 which may be configured to fluidly couple between the respective control medium power unit 371 and the respective control medium inlet 322. The control system 370 may comprise at least one proportional integration regulator (PIV) 373 which may be configured to electronically couple to the respective control medium proportional control valve 372. The control system 370 may comprise at least one process medium pressure sensor 374 which may be configured to measure the process medium pressure Ppm. The control system 370 may comprise at least one control medium drain valve 376 which may be configured to fluidly couple to the respective control medium inlet 322. The control system 370 may comprise a programmable logic controller (PLC) 375 which may be configured to execute a control system logic comprising a sequence of commands and to electrically couple to at least one of: the at least one control medium power unit 371, the at least one control medium proportional control valve 372, the at least one proportional integration regulator 373, the at least one process medium pressure sensor 374, and the at least one control medium drain valve 376. The programmable logic controller 375 may be configured to operate the displacement intensifier 320 via the control system 370 by executing the control system logic to change the process medium pressure Ppm of the process medium in at least one of a process medium chamber 323 and a pressure vessel 390, which may be mechanically and fluidly coupled to the system manifold 369.

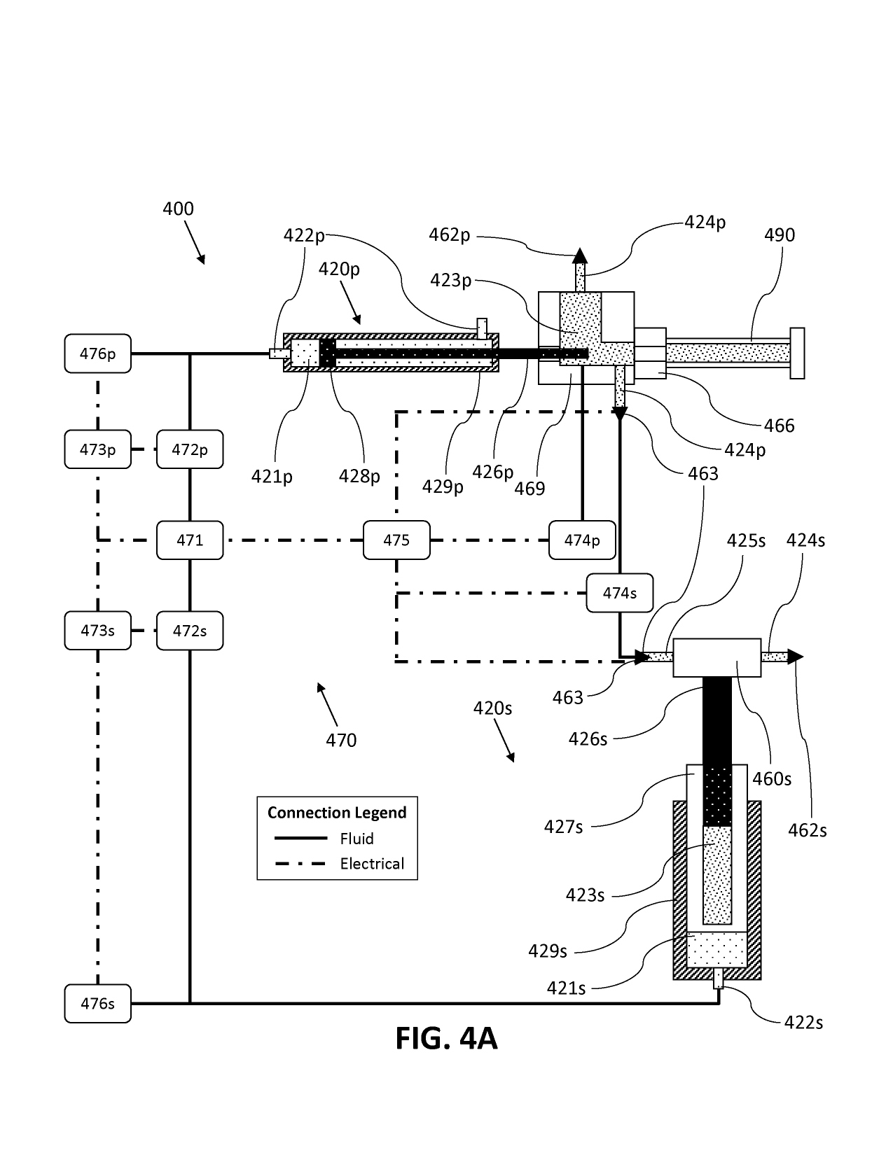

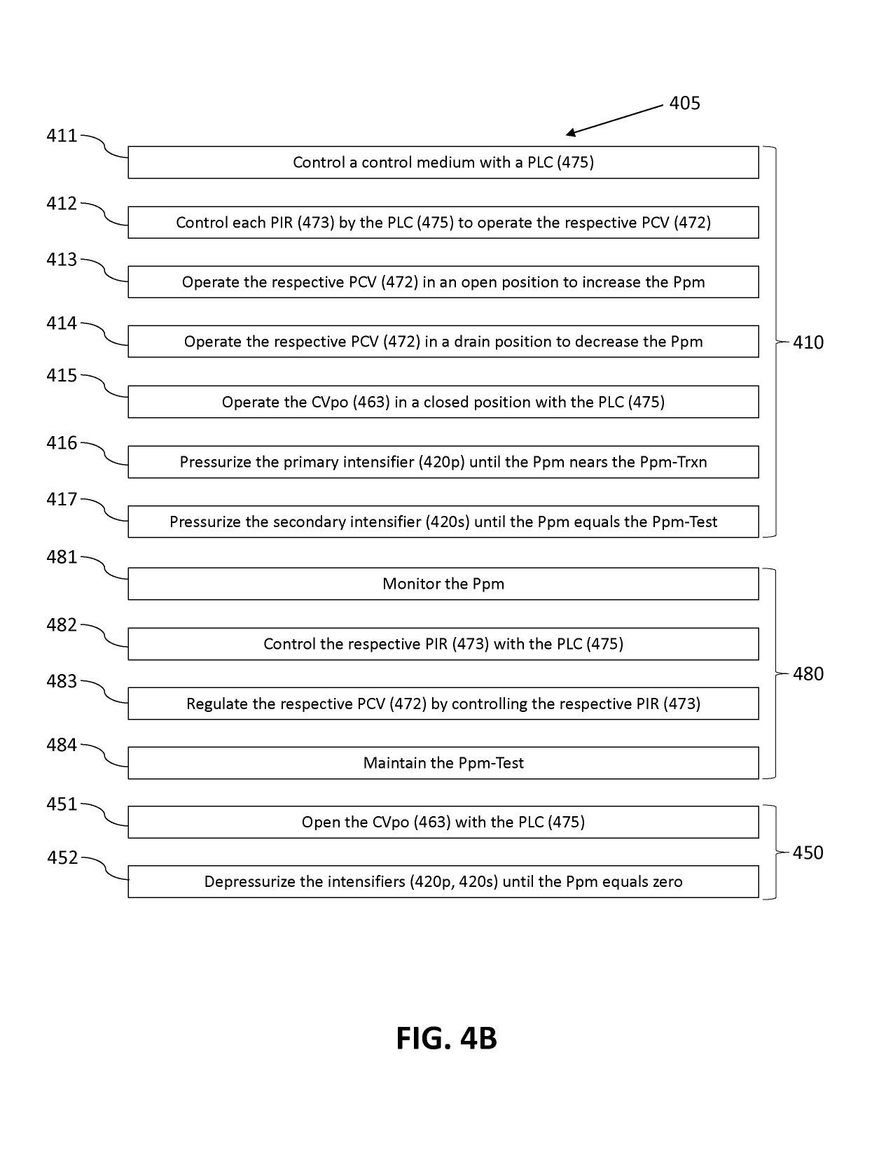

An intensifier system 400 may comprise at least one of: a primary intensifier 420p, a secondary intensifier 420s, and a control system 470. FIG. 4A illustrates a schematic of the intensifier system 400, a sectional view of the primary intensifier 420p and the secondary intensifier 420s, and a schematic for the control system 470. The primary intensifier 420p, as illustrated in FIG. 4A, may be substantially the same, in both structure and function, as the displacement intensifier 120, as illustrated in FIGS. 1A and 1B. As such, like numerals represent like elements (e.g., 120 = 420p and 124 = 424p, etc.), wherein a “p” suffix represents the primary intensifier and an “s” suffix represents the secondary intensifier.

The intensifier system 400 may comprise at least one system manifold 469, which may comprise at least one process medium intensifier inlet 424p. The at least one process medium intensifier inlet 424p may be two process medium intensifier inlets 424p, wherein a first process medium intensifier inlet 424p may be configured to fluidly couple to a process medium supply, and wherein a second, or supplemental, process medium intensifier inlet 424p may be configured to fluidly couple to the second intensifier 420s.

The secondary intensifier 420s may comprise a control medium chamber 421s which may be configured to fluidly couple to a control medium inlet 422s. The secondary intensifier 420s may comprise an intensifier manifold 460. The intensifier manifold 460 may comprise at least one of a process medium intensifier inlet 424s and a process medium intensifier outlet 425s. The secondary intensifier 420s may comprise a process medium chamber 423s which may be configured to fluidly couple to at least one of the process medium intensifier inlet 424s and the process medium intensifier outlet 425s. The secondary intensifier 420s may comprise an intensifier rod 426s through which a process medium may flow from the intensifier process medium inlet 424s, through the process medium chamber 423s, and through the intensifier process medium outlet 425s.

At least one process medium pilot-operated check valve (CVpo) 463 may be configured to fluidly couple in series between the supplemental process medium intensifier inlet 424p and the process medium intensifier outlet 425s. The secondary intensifier 420s may be configured to at least one of electrically couple and fluidly couple to a control system 470, which may be configured to control the operation of at least one of the primary intensifier 420p and the secondary intensifier 420s.

The at least one process medium pilot-operated check valve 463 may be configured in a normally closed position and in an open position when piloted. The process medium pilot-operated check valve 463 may normally function as a standard spring-operated check valve and allow the process medium to flow in only one direction. The process medium pilot-operated check valve 463 may have an external bypass cylinder. The external bypass cylinder may be operated by the pilot function of the process medium pilot-operated check valve 463 and may be controlled by the control system 470, which may be configured to send a bypass control signal to the process medium pilot-operated check valve 463. When bypassed, the process medium pilot-operated check valve 463 may no longer function as a check valve and instead may allow the process medium to flow in either direction. Alternatively, the process medium pilot-operated check valve 463 may be configured to open or close, rather than simply bypass, in response to the control signal received from the control system 470.

The primary intensifier 420p may be configured to have a capacity to withstand a process medium test pressure Ppm‑Test. The secondary intensifier 420s may be configured to pressurize the process medium to at least the process medium test pressure Ppm‑Test. One skilled in the art would understand the phrase “to have a capacity to withstand.” However, for illustrative purposes, the phrase “to have a capacity to withstand” may be defined as being designed to operate within a desired set of operational parameters without deviating from the intended operational parameters. For example, the primary intensifier 420p may comprise seals, fasteners, piping, and/or other structures that are designed to operate as designed for certain parameters such as pressures, temperatures, and the like that exceed the parameters specified in a test (e.g., greater than Ppm-Test).

The secondary intensifier 420s may have a particular type of construction or arrangement that may be selected based on its suitability for the needs of the particular application. Furthermore, the secondary intensifier 420s may comprise a plurality of intensifiers, each having various types of constructions or arrangements. For example, there are currently two common types of intensifiers: a cylinder-type intensifier and a plunger-type intensifier. The cylinder-type intensifier may have a double-acting hydraulic bottom. The extension of a rod may be encapsulated inside a thick-walled housing. A resulting cavity may be pre-filled with a process medium before a cylinder piston advances. The advancement of a cylinder piston may push the rod end into the cavity, thereby causing a displacement of the process medium into a vessel and a resulting increase in the process medium pressure. The cylinder-type intensifier may be economical to build, but it may also have a problem of allowing cross-contamination of the control medium with the process medium across a dynamic rod seal. By contrast, the plunger-type intensifier may have a moving plunger and a fixed position rod. The plunger may provide a direct separation between the control medium and the process medium. The plunger-type intensifier may be more expensive to build than the cylinder-type intensifier due to the greater number of components required to build a plunger-type intensifier, but the plunger-type intensifier may provide for lower downtime and maintenance costs.

One of the benefits of the intensifier system 400 may be that the displacement intensification capabilities of the primary intensifier 420p may allow for the use of a relatively small and inexpensive secondary intensifier 420s to provide a supplemental intensification to the primary intensifier 420p. For example, by displacing a portion of the process medium in a pressure vessel 490 with the primary intensifier 420p, the volumetric size of the pressure vessel 490 is effectively reduce and therefore the secondary intensifier 420s may need only be sized to pressurize a smaller volume of process medium than what may typically be needed without the primary intensifier 420p.

The secondary intensifier 420s may increase the process medium pressure Ppm in proportion to an intensifier amplification ratio Ri of the control medium chamber’s 421s cross-sectional area Ac to the process medium chamber’s 423s cross-sectional area Ap, such that Ri = Ac / Ap. The intensifier amplification ratio Ri may be any ratio greater than 1 to produce an increase in the process medium pressure across the secondary intensifier 420s.

The components of the intensifier system 400 may be configured to fluidly couple so as to allow the process medium to flow through the intensifier system 400 from the process medium inlet check valve 462s, through the process medium intensifier inlet 424s, through the process medium chamber 423s, through the intensifier rod 426s, through the process medium intensifier outlet 425s, through the process medium pilot-operated check valve 463, through the supplemental process medium intensifier inlet 424p, through the process medium chamber 423p, and into the pressure vessel 490.

The control system 470 illustrated in FIG. 4A may be configured to operate the intensifier system 400. The components of the control system 470, as illustrated in FIG. 4A, may be substantially the same, in both structure and function, as the components of the control system 300, as illustrated in FIG. 3. As such, like numerals represent like elements (e.g., 371 = 471 and 473 = 473p, etc.), wherein a “p” suffix represents the primary intensifier and an “s” suffix represents the secondary intensifier.

FIG. 4B illustrates a method 405 for operating an intensifier system 400 for a process medium. The intensifier system 400 may comprise a primary intensifier 420p which may be configured to fluidly couple in series with a secondary intensifier 420s. The method 405 may comprise controlling a control medium of the intensifier system 400 with a programmable logic controller (PLC) 475. The method 405 may comprise at least one of a pressurization phase 410, a depressurization phase 450, and a maintenance phase 480. The maintenance phase may be performed between the pressurization phase 410 and the depressurization phase 450.

The programmable logic controller 475 may be configured to control at least one of the pressurization phase 410, the depressurization phase 450, and the maintenance phase 480. The primary intensifier 420p may be configured to increase a pressure of the process medium Ppm within a pressure vessel 490 by partially displacing the process medium contained within the pressure vessel 490. At least one process medium pilot-operated check valve 463 may be configured to fluidly couple between the primary intensifier 420p and the secondary intensifier 420s.

During the pressurization phase 410, the method 405 may comprise: 1) pressurizing the primary intensifier 420p until the process medium pressure Ppm nears a process medium transition pressure Ppm‑Trxn, wherein the process medium transition pressure Ppm‑Trxn may be the maximum process medium pressure Ppm generated by the primary intensifier 420p; and 2) pressurizing the secondary intensifier 420s until the process medium pressure Ppm reaches a process medium test pressure Ppm‑Test. The at least one process medium pilot-operated check valve 463 may be operated by the programmable logic controller 475 in a closed position during the pressurization of the primary intensifier 420p. Alternatively, the at least one process medium pilot-operated check valve 463 may be operated by the programmable logic controller 475 in a normal, non-bypassed position during the pressurization of the primary intensifier 420p.

During the pressurization phase 410, the method 405 may comprise controlling each proportional integration regulator 473p, 473s by the programmable logic controller 475 to operate the respective control medium proportional control valve 472p, 472s. Operating the respective control medium proportional control valve 472p, 472s in an open position may increase the process medium pressure Ppm. Operating the respective control medium proportional control valve 472p, 472s in a drain position may decrease the process medium pressure Ppm.

During the depressurization phase 450, the method 405 may comprise: 1) opening and/or bypassing the at least one process medium pilot-operated check valve 463 with the programmable logic controller 475; and 2) depressurizing at the primary intensifier 420p and the secondary intensifier 420s until the process medium pressure Ppm nears or reaches zero. The primary intensifier 420 may be depressurized, either fully or partially, before the secondary intensifier 420s is depressurized. Conversely, the secondary intensifier 420s may be depressurized, either fully or partially, before the primary intensifier 420p is depressurized. Alternatively, both the primary intensifier 420 and the secondary intensifier 420s may be depressurized simultaneously, which may desirably increase the rate of depressurization of the intensifier system 400.

At least one pressure sensor 474p may be configured to measure the process medium pressure Ppm within the primary intensifier 420p. At least one control medium proportional control valve 472p, 472s may be configured to pressurize the respective intensifier 420p, 420s. At least one proportional integration regulator 473p, 473s may be configured to control the respective control medium proportional control valve 472p, 472s. The programmable logic controller 475 may be configured to control each proportional integration regulator 472p, 472s.

At least one intensifier 420p, 420s may comprise at least one of a rod 426p, 426s, a plunger 427s, and a piston 428p, any of which may be configured to transmit a pressure between the control medium and the process medium. During the depressurization phase 450, the method 405 may comprise controlling a return of at least one of the respective rod 426p, 426s, the respective plunger 427s, and the respective piston 428p to a zero-displacement starting position with the respective control medium proportional control valve 472p, 472s.

Due to the arrangement(s) and the operation(s) of the at least one process medium pilot-operated check valve 463, the intensifier system 400 may be depressurized without the use of an additional process medium depressurization valve positioned between the primary intensifier 420p and the pressure vessel 490. This may reduce the complexity, the cost, the maintenance, and/or otherwise simplify the intensifier system 400.

During the maintenance phase 480 the method 405 may comprise: 1) monitoring the process medium pressure Ppm; 2) controlling the respective proportional integration regulator 473p, 473s with the programmable logic controller 475; 3) regulating the respective control medium proportional control valve 472p, 472s by controlling the respective proportional integration regulator 473p, 473s; and 4) maintaining the process medium pressure Ppm at the process medium test pressure Ppm‑Test.

During the maintenance phase 480, the primary intensifier 420p may control the process medium pressure Ppm by extending the rod 426p into and out of at least one of the system manifold 469 and the pressure vessel 490. In this embodiment, the at least one process medium pilot-operated check valve 463 may be operated in the closed or non-bypassed position. Alternatively, the secondary intensifier 420p may control the process medium pressure Ppm by advancing the plunger 427s of the secondary intensifier 420s. In this embodiment, the at least one process medium pilot-operated check valve 463 may be operated in the open or bypassed position.

The at least one process medium pilot-operated check valve 463 may comprise a bypass cylinder which may be configured to be controlled by the programmable logic controller 475 and bypass the at least one process medium pilot-operated check valve 463 when the at least one process medium pilot-operated check valve 463 is in the open position. Alternatively, the at least one process medium pilot-operated check valve 463 may be configured to open or close, rather than simply bypass, in response to the control signal received from the programmable logic controller 475.

In an embodiment where there is more than one process medium pilot-operated check valve 463, each of the process medium pilot-operated check valves 463 may comprise the same function and/or configuration. For example, each of the process medium pilot-operated check valves 463 may be configured to open and close upon receiving a pilot signal from the programmable logic controller 475. Similarly, each of the process medium pilot-operated check valves 463 may be configured to bypass the check valve upon receiving a pilot signal from the programmable logic controller 475. Alternatively, each of the process medium pilot-operated check valves 463 may comprise a different function and/or configuration. For example, at least one of the process medium pilot-operated check valves 463 may be configured to open and close upon receiving a pilot signal from the programmable logic controller 475, while at least one of the process medium pilot-operated check valves 463 may be configured to bypass the check valve upon receiving a pilot signal from the programmable logic controller 475.

The pressurization phase 410 may begin with the primary intensifier 420p increasing the process medium pressure Ppm to the process medium transition pressure Ppm‑Trxn, which may be the maximum pressure the primary intensifier 420p may produce. The pressurization phase 410 may continue with the secondary intensifier 420s increasing the process medium pressure Ppm to reach the process medium test pressure Ppm‑Test. The process medium test pressure Ppm‑Test may be transferred to the pressure vessel 490, which may be configured to mechanically and fluidly couple to the system manifold 469. The pressure vessel 490 may be a tank, a pipe, or the like, and may be configured to contain the pressurized process medium.

The process medium pressure Ppm produced by the intensifiers 420p, 420s may be controlled by the control system 470, comprising at least one of: the control medium power unit 471, the control medium proportional control valve 472p, 472s, the proportional integration regulator 473p, 473s, the process medium sensor 474p, 474s, and the programmable logic controller 475.

The at least one process medium pilot-operated valve 463 may be configured to operate in a normally closed position, thereby preventing the process medium pressure generated by the primary intensifier 420p from entering the secondary intensifier 420s. When operating both of the intensifiers 420p, 420s, the process medium pressure Ppm in the primary intensifier 420p may effectively be fluidly coupled to the pressure vessel 490. However, the secondary intensifier 420s may be fluidly separated from the primary intensifier 420p by the closed process medium pilot-operated check valve 463 and therefore may remain at the process medium test pressure Ppm‑Test that the secondary intensifier 420s produced after the primary intensifier 420p produced the process medium transition pressure Ppm‑Trxn. When the at least one process medium pilot-operated check valve 463 is operated in the open or bypassed position, the process medium pressure Ppm may be decreased with a reduction of the control medium pressure Pcm in the control medium chamber 421s of the secondary intensifier 420s. However, to prevent potential damage to the secondary intensifier 420s, the at least one process medium pilot-operated check valve 463 may be configured to operate in the open or bypassed position before depressurizing the secondary intensifier 420s.

A traditional intensifier system (not pictured), having two intensifiers fluidly coupled in series with a conventional spring-operated check valve fluidly coupled between the intensifiers, may require an additional process medium dump valve in order to relieve the process medium pressure from the traditional intensifier system between a process medium outlet and a fluidly coupled pressure vessel. This may be because the process medium pressure can only decrease to a process medium pressure transition pressure due the presence of the spring-operated check valve. If the control medium pressure in a first, upstream intensifier were to decrease, the process medium pressure downstream of the spring-operated check valve would decrease, but the process medium pressure inside the second, downstream intensifier and the pressure vessel would remain the same. This is why an additional process medium dump valve may be required to evacuate the process medium pressure in the pressure vessel and the second, downstream intensifier. This additional process medium dump valve may exhibit issues with excessive wear and create a potentially damaging fluid or mechanical shock in the intensifier system, since the additional process medium dump valve is traditionally an instant-open valve and may not allow for a smooth transition from a full process medium pressure to a zero process medium pressure.

By contrast, with the addition of the external bypass cylinder built into the at least one process medium pilot-operated check valve 463, it may now be possible to decrease the process medium pressure Ppm in both of the intensifiers 420p, 420s by energizing a control signal override of the at least one process medium pilot-operated check valve 463, which may lift a check cartridge away from a check seat at a specific process medium pressure Ppm in the depressurization phase 450. This functionality may allow for a full bypass from both of the intensifiers 420p, 420s. An additional possible advantage may be that the rate of decompression of the intensifiers 420p, 420s may be controlled by the respective control medium proportional control valve 472p, 472s configured to fluidly couple to the respective control medium inlet 422p, 422s and therefore provide for a faster decrease of the process medium pressure Ppm. Additionally, by using the process medium test pressure Ppm‑Test contained in the intensifier system 400, the plunger 427s located in the secondary intensifier 420s and the piston 428p located in the primary intensifier 420p may be returned to their respective home positions (i.e., their zero-displacement starting positions, such as when there is substantially no volume of control medium in their respective control medium chambers 421p, 421s) without the assistance of an external device. For example, by converting a stored energy of the process medium in a controlled volume in the intensifier system 400 to a kinetic energy, the plunger 427s located in the secondary intensifier 420s and the piston 428p located in the primary intensifier 420p may be returned to their starting positions by the kinetic energy and therefore may eliminate a need to have external devices to return the plunger 427s and the piston 428p to their starting positions and to push the remaining control medium out of the intensifier system 400 through the respective control medium proportional control valves 472p, 472s.

Furthermore, in situations where the process medium test pressure Ppm is less than the process medium transition pressure Ppm‑Trxn, the at least one process medium pilot-operated check valve 463 may remain in the pilot-operated open position and the secondary intensifier 420s may function as though it would if it were a single intensifier operating without the primary intensifier 420p. This may be useful in cases where a diameter of the rod 426p of the primary intensifier 420p is either too large or two small to be used effectively. For example, when the diameter of the rod 426p is too large, the rod 426p may not physically fit into the pressure vessel 490. And when the diameter of the rod 426p is too small, the rod 426p may not contribute a useful increase of the process medium pressure Ppm when a diameter of the pressure vessel 490 is relatively large compared to the diameter of the rod 426p.

A benefit of the at least one process medium pilot-operated check valve 463 may be in the depressurization phase 450 when the intensifiers 420p, 420s may begin to decompress and return to their zero-displacement starting positions. The process medium stored in the pressure vessel 490 may be returned to the primary intensifier 420p by means of proportionally expelling the control medium to return the piston 428p of the primary intensifier 420p to its zero-displacement starting position. Only a portion of the process medium stored in the pressure vessel may be used to return the piston 428p of the primary intensifier 420p to its zero-displacement starting position. The remaining process medium may then be trapped by the low-pressure check valve in a traditional intensifier system, but with the at least one process medium pilot-operated check valve 463, the process medium pressure in both of the intensifiers 420p, 420s may be equalized. This pilot-operated function may allow for the process medium remaining in the intensifier system 400 to return the plunger 427s of the secondary intensifier 420s to its zero-displacement starting position, thereby exhausting the process medium pressure Ppm in the intensifier system 400.

During the depressurization phase 450, a rate of return for the process medium in the intensifier system 400 may be proportionally controlled through the same control medium proportional control valves 472p, 472s that may be used to transfer the control medium pressure Pcm from the control medium power unit 471 to the control medium chambers 421p, 421s. The rate of return may be proportionally controlled through the position feedback of the plunger 427s and the piston 428p and may allow the programmable logic controller 475 to regulate the control medium proportional control valves 472p, 472s at different positions and therefore control the final approach of the plunger 427s and the piston 428p to allow for a reduced fluid or mechanical shock in the intensifier system 400. Using the same control medium proportional control valves 472p, 472s to both pressurize and depressurize the intensifiers 420p, 420s may reduce the need for additional control medium components required to provide a low resistance return path for the plunger 427s and the piston 428p.

Furthermore, a design, a sizing, and a control of the at least one process medium pilot-operated check valve 463 may be selected in order to prevent a premature shifting of the at least one process medium pilot-operated check valve 463 during the depressurization phase 450. A control timing of the at least one process medium pilot-operated check valve 463 may be determined based on the design, the sizing, and other parameters to reduce the timing requirements in the programmable logic controller 475. If the primary intensifier 420p is depressurized before the secondary intensifier 420s is depressurized, the at least one process medium pilot-operated check valve 463 may be energized at any time during the depressurization of the primary intensifier 420p, and in this case, the release timing of the at least one process medium pilot-operated check valve 463 may be non-critical and may provide for a smooth and consistent transition that is independent of both the process medium test pressure Ppm and the size of the intensifier system’s 400 control medium volume.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in the manufacturing of intensification products. To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively connected,” “fluidly coupled,” “mechanically coupled,” and “electrically coupled” are used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ± 10 % of the number. In other words, “about 10” may mean from 9 to 11.

As stated above, while the present application has been illustrated by the description of embodiments and aspects thereof, and while the embodiments and aspects have been described in considerable detail, it is not the intention of the applicant to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An intensifier system comprising:
An intensifier comprising:
an intensifier cylinder comprising:
a control medium chamber configured to contain a pressurized control medium and to fluidly couple to at least one control medium inlet, and
an intensifier piston configured to mechanically couple to an intensifier rod which extends from a first face of the intensifier piston;
a system manifold comprising:
a process medium chamber configured to contain a pressurized process medium and to fluidly couple to at least one process medium intensifier inlet, and
at least one process medium inlet check valve configured to fluidly couple to the respective process medium intensifier inlet; and
wherein the intensifier rod is configured to extend axially from the intensifier cylinder, through the system manifold, and into the process medium chamber,
wherein the pressure of the process medium within the process medium chamber changes in proportion to the length of the intensifier rod extending into the process medium chamber, and
wherein the intensifier is configured to change the process medium pressure upon receiving commands from an intensifier control system.

2. The intensifier system of claim 1, further comprising a coupler configured to:
mechanically couple the system manifold to a pressure vessel, and
fluidly couple the process medium chamber to the pressure vessel.

3. The intensifier of claim 2, wherein the intensifier is configured to move fore and aft relative to the system manifold along the axis of the intensifier rod, and
wherein the intensifier rod is further configured to extend into the pressure vessel.

4. The intensifier system of claim 3, wherein the coupler further comprises a clamp assembly configured to mechanically align and secure a tooling assembly within the clamp assembly,
wherein the tooling assembly is configured to mechanically align and secure the pressure vessel to the clamp assembly.

5. The intensifier ofclaim 4, wherein the tooling assembly is configured to be at least one of adjustable and interchangeable to be adaptable to mechanically couple the clamp assembly to pressure vessels having various configurations, shapes, sizes, and weights.

6. An intensifier system comprising:
an intensifier comprising:
an intensifier cylinder comprising:
a control medium chamber configured to contain a pressurized control medium and to fluidly couple to at least one control medium inlet, and
an intensifier piston configured to mechanically couple to an intensifier rod which extends from a first face of the intensifier piston;
a system manifold comprising:
a process medium chamber configured to contain a pressurized process medium and to fluidly couple to at least one process medium intensifier inlet, and
at least one process medium inlet check valve configured to fluidly couple to the respective process medium intensifier inlet; and
a coupler configured to:
mechanically couple the system manifold to a pressure vessel, and
fluidly couple the process medium chamber to the pressure vessel;
wherein the intensifier rod is configured to extend axially from the intensifier cylinder, through the system manifold, and into the process medium chamber, and
wherein the pressure of the process medium within the process medium chamber changes in proportion to the length of the intensifier rod extending into the process medium chamber; and
a control system configured to operate the intensifier, the control system comprising:
at least one control medium power unit;
at least one control medium proportional control valve configured to fluidly couple between the respective control medium power unit and the respective control medium inlet;
at least one proportional integration regulator configured to electronically couple to the respective control medium proportional control valve;
at least one process medium pressure sensor configured to measure the process medium pressure;
at least one control medium drain valve configured to fluidly couple to the respective control medium inlet, and
a programmable logic controller configured to execute a control system logic comprising a sequence of commands and to electrically couple to at least one of:
the at least one control medium power unit,
the at least one control medium proportional control valve,
the at least one proportional integration regulator,
the at least one process medium pressure sensor, and
the at least one control medium drain valve.

7. The intensifier system of claim 6, wherein the intensifier is configured to move fore and aft relative to the system manifold along the axis of the intensifier rod, and
wherein the intensifier rod is further configured to extend into the pressure vessel.

8. The intensifier system of claim 7, wherein the intensifier is a primary intensifier; and
further comprising a secondary intensifier comprising:
a control medium chamber configured to fluidly couple to a control medium inlet; and
a process medium chamber configured to fluidly couple to both a process medium intensifier inlet and a process medium intensifier outlet;
wherein the process medium pilot-operated check valve is configured to fluidly couple in series between the process medium intensifier outlet of the secondary intensifier and the process medium intensifier inlet of the primary intensifier, and
wherein the secondary intensifier is configured to at least one of electrically couple and fluidly couple to the control system, and
wherein the control system is further configured to control the operation of the primary intensifier.

9. The intensifier system of claim 8, wherein the secondary intensifier is either a plunger-type intensifier or a cylinder-type intensifier.

10. The intensifier system of claim 8, wherein the secondary intensifier is configured to pressurize the process medium to at least a process medium test pressure, and wherein the primary intensifier is configured to have a capacity to withstand the process medium test pressure.

11. A method for operating an intensifier system for a process medium, comprising:
controlling a control medium of the intensifier system with a programmable logic controller,
wherein the intensifier system comprises a primary intensifier configured to fluidly couple in series to a secondary intensifier, and
wherein the primary intensifier is configured to increase a pressure of the process medium within a pressure vessel by partially displacing the process medium contained within the pressure vessel;
wherein the programmable logic controller is configured to control a pressurization phase and a depressurization phase;
during the pressurization phase, pressurizing the primary intensifier until the process medium pressure nears a process medium transition pressure,
wherein the process medium transition pressure is the maximum process medium pressure generated by the primary intensifier; and
pressurizing the secondary intensifier until the process medium pressure reaches a process medium test pressure,
wherein a process medium pilot-operated check valve is configured to fluidly couple between the primary intensifier and the secondary intensifier,
wherein the process medium pilot-operated check valve is operated by the programmable logic controller in a closed position;
during the depressurization phase, opening the process medium pilot-operated check valve with the programmable logic controller; and
depressurizing the primary intensifier and the secondary intensifier until the process medium pressure nears or reaches zero.

12. The method of claim 11, further comprising:
at least one pressure sensor configured to measure the process medium pressure within the primary intensifier;
at least one control medium proportional control valve configured to pressurize the respective intensifier;
at least one proportional integration regulator configured to control the respective control medium proportional control valve;
wherein the programmable logic controller is configured to control each proportional integration regulator; and
during the pressurization phase, controlling each proportional integration regulator by the programmable logic controller to operate the respective control medium proportional control valve,
wherein operating the respective control medium proportional control valve in an open position increases the process medium pressure, and
wherein operating the respective control medium proportional control valve in a drain position decreases the process medium pressure.

13. The method of claim 12, wherein the programmable logic controller is configured to control a maintenance phase;
the method further comprising:
performing the maintenance phase between the pressurization phase and the depressurization phase, comprising:
monitoring the process medium pressure;
controlling the respective proportional integration regulator with the programmable logic controller;
regulating the respective control medium proportional control valve by controlling the respective proportional integration regulator; and
maintaining the process medium pressure at or near the process medium test pressure.

14. The method ofclaim 13, wherein the process medium pilot-operated check valve comprises a bypass cylinder, and
wherein the bypass cylinder is configured to be controlled by the programmable logic controller and bypass the process medium pilot-operated check valve when the process medium pilot-operated check valve is in the open position;
wherein at least one intensifier comprises at least one of a rod, a plunger, and a piston; and
wherein at least one of the rod, the plunger, and the piston are configured to transmit a pressure between the control medium and the process medium; and
the method further comprising in the depressurization phase:
controlling a return of at least one of the respective rod, the respective plunger, and the respective piston to a zero-displacement starting position with the respective control medium proportional control valve.

15. The method of claim 14, wherein the primary intensifier further comprises:
an intensifier cylinder comprising:
a control medium chamber configured to contain the pressurized control medium and to fluidly couple to at least one control medium inlet, and
wherein the intensifier piston is configured to mechanically couple to the intensifier rod which extends from a first face of the intensifier piston;
a system manifold comprising:
a process medium chamber configured to contain the pressurized process medium and to fluidly couple to at least one process medium intensifier inlet, and
a process medium inlet check valve configured to fluidly couple to a respective process medium intensifier inlet;
wherein the intensifier rod is configured to extend axially from the intensifier cylinder, through the system manifold, and into the process medium chamber, and
wherein the process medium pressure within the process medium chamber changes in proportion to the length of the intensifier rod extending into the process medium chamber.

16. The method ofclaim 15, wherein the intensifier cylinder is configured to move fore and aft relative to the system manifold along the axis of the intensifier rod, and
wherein the intensifier rod is further configured to extend into the pressure vessel.

17. The method ofclaim 16, wherein the secondary intensifier is configured to pressurize the process medium to at least the process medium test pressure, and wherein the primary intensifier is configured to have a capacity to withstand the process medium test pressure.

18. The method of claim 17, wherein the intensifier system is depressurized without the use of an additional process medium depressurization valve positioned between the primary intensifier and the pressure vessel.
